(19) United States
(12) Patent Application Publication
(10) Pub. No.: US 2014/0192051 A1
(43) Pub. Date: Jul. 10, 2014

(54) Offloading Tessellation from a Graphics Processor to a Central Processing Unit

(71) Applicant: Etay Meiri, Haifa (IL)

(72) Inventor: Etay Meiri, Haifa (IL)

(21) Appl. No.: 13/992,731

(22) PCT Filed: Mar. 30, 2012
(86) PCT No.: PCT/US12/31335

§ 371 Date: Jun. 8, 2013

(51) Int. Cl. G06T 17/20; G06T 1/20

(52) U.S. Cl. CPC G06T 17/20; G06T 1/20
USPC 345/423

(57) ABSTRACT

In accordance with some embodiments, tessellation may be implemented in part on a central processing unit and in part on a graphics processing unit. The part that may be performed on a central processing unit may be a pre-computation stage in which the possible combinations of vertex stitching are computed and stored as a bit mask in a bidirectional array. Then, at run time, the graphics processor runs through the vertices as pre-computed in the central processing unit, in some embodiments.

### BACKGROUND

This relates generally to graphics processing and particularly to tessellation.

Tessellation populates a model with a larger number of smaller primitives (e.g. triangles, lines or points) to create a more accurate graphical representation of the origin of the model. In general, tessellation takes a control point mesh and divides it into smaller triangles to improve the visual quality of a rendered scene.

Tessellation involves taking an equilateral triangle or square specified in barycentric coordinates and tessellates it with smaller triangles that are also specified in barycentric coordinates. The process usually involves first generating new vertices inside the triangles and then stitching or connecting those vertices together in order to tessellate the entire area of the original triangle with geometric shapes such as triangles or quadrilaterals.

The DirectX11 pipeline specifies expected results of the stages based on input values that indicate the tessellation level as well as configuration attributes. The tessellator is a software or hardware component that actually performs the tessellation. It is provided with two, four or six (depends on whether we are tessellating a line, triangle or quad, respectively) floating point values called tessellation factors. The tessellation factors specify the number of segments along an edge of a shape to be tessellated, such as a triangle. There is one tessellation factor per triangle edge as well as an inner tessellation factor that determines a number of rings between an edge and the triangle center. Each ring is made up of smaller triangles or quadrilaterals that generally run parallel and concentric to the outer edges of the triangle being tessellated.

Based on the value of the tessellation factors, and the configuration parameters, the tessellator generates new vertices across the entire triangle surface. Then the vertices are stitched together to cover the original triangle with smaller triangles.

### BRIEF DESCRIPTION OF THE DRAWINGS

Some embodiments are described with respect to the following figures:

FIG. 1 is a depiction of a graphics pipeline in accordance with one embodiment;

FIG. 2 is a depiction of a lower portion of a triangle to be tessellated in accordance with one embodiment;

FIG. 3 is a flow chart for a portion of the tessellation operation that may be offloaded to the central processing unit in one embodiment;

FIG. 4 is a flow chart for a portion of the tessellation operation that may be performed on a graphics processor in some embodiments;

FIG. 5 is a schematic depiction of a system in accordance with one embodiment; and

FIG. 6 is a front elevational view of one embodiment of the present invention.

### DETAILED DESCRIPTION

In accordance with some embodiments, tessellation may be implemented in part on a central processing unit and in part on a graphics processing unit or fully on either one. The part that may be performed on a central processing unit may be a pre-computation stage in which the possible combinations of vertex stitching are computed and stored as a bit mask in a bidirectional array. Then at run time, in the graphics processor or the central processing unit, a tessellator portion runs through the vertices as pre-computed in the central processing unit in some embodiments.

Stitching of different pairs of tessellation factors is equivalent as long as a number of segments is the same. This means that, while the total number of theoretical stitching possibilities is huge, in reality, a DirectX11 compliant tessellator only generates no more than 4,095 different results. This is made up of 65 points on a given external edge of the triangle multiplied by no more than 63 points on the first inner edge.

Stitching may be mirrored across the centers of the external edges and the internal edges in front of the external edge. There are only four possible cases for the center. The center may be a quad in the form of two triangles, an inwardly facing triangle, an outwardly facing triangle or a null center. A null center is simply an arrangement with no center. Checking for the specific case according to the combination of outer and inner points and emitting the correct topology is relatively simple. This may be done, for example, by checking whether the combination of inner and outer number of segments includes two odd numbers, two even numbers, and odd and even numbers or an even and odd number. Based on the result, the tessellator emits one of the four possible cases for the center.

In the following discussion, DirectX application program interface (API) terminology is generally used. In all cases, corresponding structures may be found in other application program interfaces including OpenGL. Thus the discussion that follows is applicable to any application program interface used for graphics processing.

A control cage is a low resolution model used by artists to generate smooth surfaces. By providing a higher degree of tessellation, the level of graphical detail that can be depicted is greater. However processing speed may be adversely affected by greater degrees of tessellation.

A patch is a basic unit at a coarse level describing a control cage for a surface. The surface can be any surface that can be described as a parametric function.

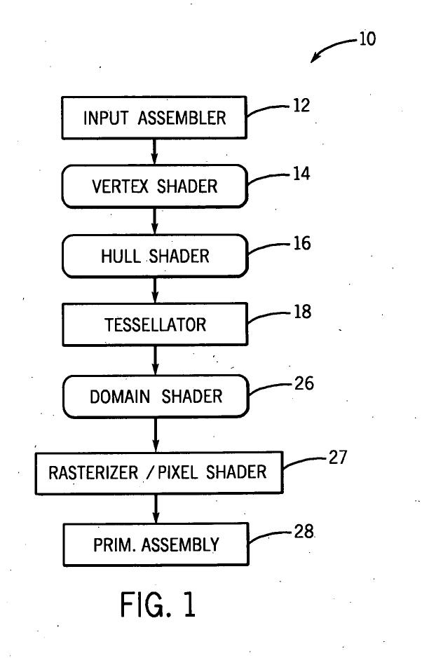

The graphics pipeline 10 shown in FIG. 1 may be implemented in a graphics processor as a stand-alone, dedicated integrated circuit, or software, through software implemented general purpose processors, or by combinations of software and hardware. In some embodiments, elements depicted in FIG. 1 with right angle edges can be implemented in hardware and elements depicted in FIG. 1 with rounded edges can be in software. A wide variety of software and hardware components may be used. For example, the entire pipeline, except for the rasterizer, may be software or the entire pipeline may be implemented in software.

The graphics pipeline may be implemented for example in a wireless telephone, a mobile hand-held computing device that incorporates a wired or wireless communication device or any computer. The graphics pipeline may provide images or video for display to a display device. Various techniques can be used to process images provided to the display.

The input assembler 12 reads vertices out of memory using fixed function operations, forming geometry, and creating pipeline work items. Automatically generated identifiers enables identifier-specific processing. Vertex identifiers and instance identifiers are available from the vertex shader 14 onward. Primitive identifiers are available from the hull shader 16 onward. The control point identifiers are available in the hull shader 16.

The vertex shader performs operations such as transformation, skinning or lighting. It inputs one vertex and outputs one vertex. The control point phase (part of the hull shader) is invoked per output control point and each identified by a control point identifier.

The hull shader 16 control-point phase outputs one control point per invocation. The aggregate output is a shared input to the next hull shader phase and to the domain shader 26. Patch constant phases may be invoked once per patch with shared read input of all input and output control points. The hull shader 16 outputs edge tessellation factors and other patch constant data. As used herein, edge tessellation factor and edge level of detail with a number of intervals per edge of the primitive domain may be used interchangeably. Codes are segmented so that independent work can be done with parallel finishing with a join step at the end.

The tessellator 18 may be implemented in hardware or in software. In some advantageous embodiments, the tessellator may be a software implemented tessellator. The tessellator 18 generates encoded domain points or (u, v, w) values. The tessellator 18 receives, from the hull shader, numbers defining how much to tessellate. The tessellator 18 generates topologies, such as points, lines or triangles. Tessellator 18 may output domain locations.

The domain shader 24 is a programmable stage that uses the domain point's (u, v, w) values, supplied by the tessellator 18 to generate a real three-dimensional vertex on a patch. The domain shader 26 evaluates vertex positions and attributes and optionally displaces the points by looking up displacement maps. The domain shader 26 may evaluate a vertex's normal and other attributes using (u, v, w) values from the tessellator 18. High frequency detail of the patch can be added using a displacement map. In some embodiments, the domain shader 26 may be software implemented.

The domain shader 26 may displace a point using a scalar displacement map or calculate other vertex attributes. In some cases, the vertex evaluations may involve the determination of a bi-cubic polynomial (or higher ordered polynomial in general) for positions, calculating partial derivatives or evaluating the tangent and bi-tangent using auxiliary tangent and bi-tangent control cages and taking their cross products, performing a textured lookup with some filtering such as linear filtering, displacing a point along a normal in the case of scalar value displacements, and displacing a point along the directions that could potentially be read from other texture ease in the case of vector value displacements.

The rasterizer 27 converts primitives into pixels that are fed to a pixel shader. The rasterizer may also perform clipping and/or interpolating.

The primitive assembler 28 assembles the resulting primitives and provides the assembled primitives to later stages of the pipeline that, in turn, provide fixed function target rendering, blending, depth and stencil operations.

In an initial stage called the system creation stage, a pre-computation may be done offline with respect to the graphics processor, for example in a central processing unit. This may involve the generation of all the possible stitching combinations and storing them as a bit map in a bidirectional array. These values may be pre-computed offline, for example using the reference tessellator provided by Microsoft® in a DirectX11 embodiment. In another embodiment instead of using the DirectX11 pipeline, an OpenGL 4.0 pipeline may be used as another example.

At render time, typically in a graphics processor, a sequence begins with a first vertex on an external edge of the triangle to be tessellated and the first vertex in the internal edge. Then the vertices are traversed from start to finish.

Based on the previously stored bit map, the tessellator advances at run time on the exterior edge to the next vertex on the exterior edge if the corresponding bit in the bit mask is one in one embodiment or an internal edge if the corresponding bit in the bit mask is zero. At each step, a triangle is produced that is made up of two old vertices and one new vertex that was advanced to based on the stored bit mask. The advanced two vertices are either internal or external vertices depending on the direction stored in the bit mask. When the center is reached it may be handled according to the four combinations of odd and even points on the inner and outer edges. That is, it may be made up of a quad of two triangles, an inwardly facing triangle, an outwardly facing triangle, or a null center. Then the flow continues to the end by looking at the bit mask in reverse to handle the other half of each triangle edge.

The actual number of tessellated triangles between the internal and external rows may be 126 in a DirectX11 embodiment. But since the triangles are mirrored across the center, it is only necessary to store half of the bits, in this example 64 bits for the bit mask. Thus in a DirectX11 example, this means eight bytes are needed per 4,095 tessellation factor combinations for a total of almost 32K bytes.

In the pre-computation phase the flow iterates a variable i from one to sixty-five to represent the external edges. A variable INT64bitmask may be set equal to the referenced tessellatortobitmask (i, j) variable and a variable cache [i, j] may be set equal to the variable bitmask.

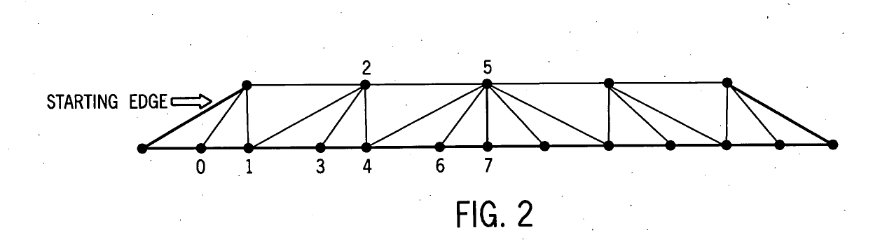

For example, the trapezoidal portion of a triangle to be tessellated, shown in FIG. 2, may be tessellated by proceeding from the edge of one triangle to the edge of the next triangle. The lower points i are points on the external edge and the upper points j are points on an internal edge just inward of an external edge at the bottom of a triangle.

The sequence of progression is indicated by numbering the vertices from zero to seven. The middle of the outer edge is at vertex five at the middle of the inner edge. Thus, in the sequence shown as an example in FIG. 2, the bit mask value is 11011011, where one in this example means stepping on the external vertices and zero indicates stepping on the internal vertices.

At render time typically in a graphics processor, the variable INT64bitmask is set equal to the variable cache [extnumofsegments] [intnumofsegments] or a bidirectional array of a size of equal to the number of external segments which may be 65 in a DirectX11 embodiment in one dimension and the number of internal segments which may be 63 in a DirectX11 embodiment which are the number of internal segments. Then i is iterated from one to the sum of the external number of segments plus the internal number of segments, that sum divided by two. Thus if a bit i in the bit mask is set, namely one, you step one vertex on the external edge and otherwise you step one vertex on the internal edge. Then the bit mask is reversed and the loop is repeated from the center until the end of the opposite (right) outer edge.

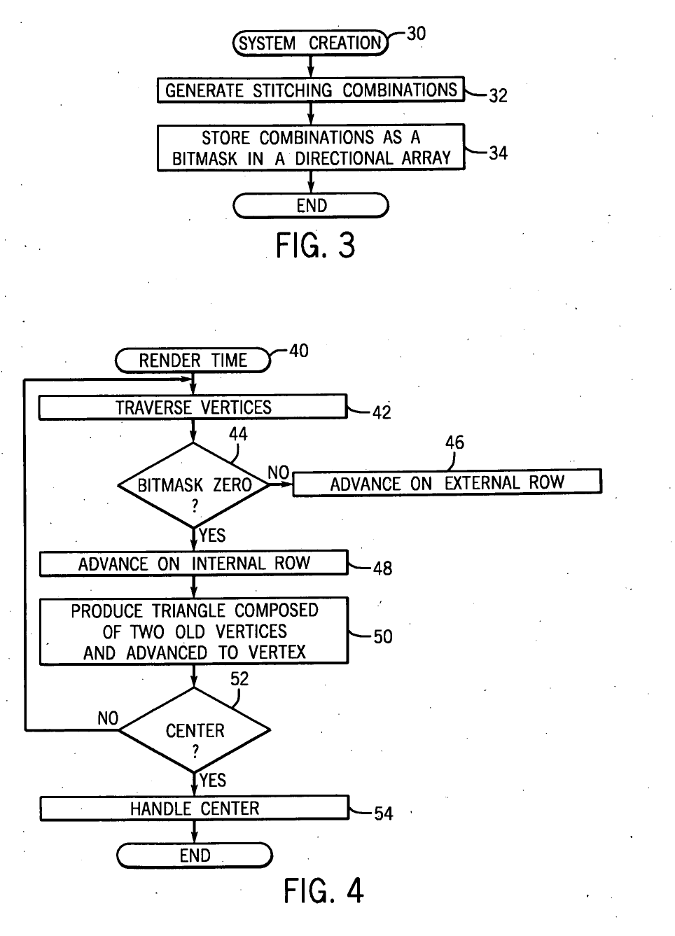

The sequence 30 shown in FIG. 3 may be implemented in software, hardware or firmware. In some embodiments it may be implemented by computer executed instructions stored in a non-transitory computer readable medium such as a magnetic, semiconductor or optical storage. For example it may be executed by the central processing unit and stored in and associated with system memory as one example.

Referring to FIG. 3, the system creation step represents the pre-computation stage. The sequence 30 in some embodiments may be pre-computed in a central processing unit. The sequence begins by generating all the stitching combinations as indicated in block 32. In the case of a DirectX11 embodiment, there are 4,095 stitching combinations (65×63). Then the combinations are stored as a bit mask in a bidirectional array as indicated in block 34.

Next, at run time, the sequence 40 shown in FIG. 4 may be implemented. It may be implemented in software, hardware and/or firmware. In software and firmware embodiments it may be implemented by computer executed instructions stored in a non-transitory computer readable medium such as an optical, magnetic or semiconductor storage. It may be executed in some embodiments in a graphics processing unit and stored in a memory onboard the graphics processing unit as one example.

The sequence 40 begins by traversing the vertices as indicated by block 42. The vertices are traversed by iterating i from one to the sum of the number of external segments plus the number of internal segments divided by two in some embodiments. This is because it is only necessary to do half of each external and internal edges and then you can simply duplicate by reversing progression through the bit mask.

A check at diamond 44 determines whether the bit mask value in the bi-directional array is zero. If not, you advance on an external edge as indicated in block 46. Otherwise you advance on an internal edge as indicated in block 48. Finally a triangle is produced that is composed of two old vertices and an advanced to vertex as indicated in block 50. A check at diamond 52 determines whether the center has been reached. If not, the flow iterates to continue traversing the triangle vertices.

If the center has been reached, then it is handled in one of the four cases, namely as a quad of two triangles, using an inwardly facing triangle, using an outwardly facing triangle or using the null center as indicated in block 54.

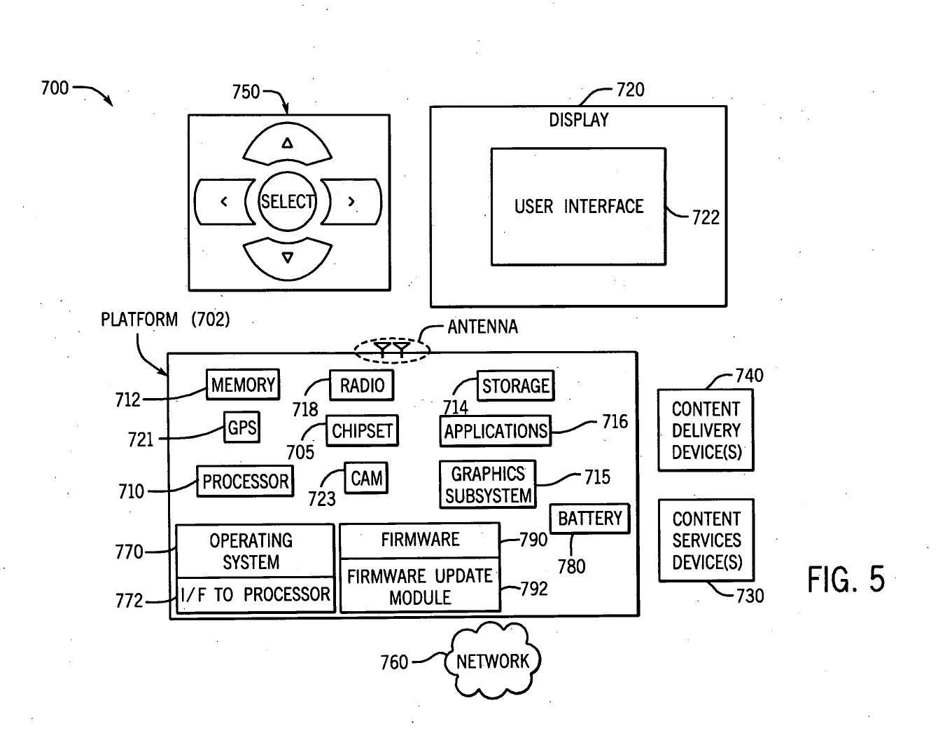

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716, global positioning system (GPS) 721, camera 723 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

In addition, the platform 702 may include an operating system 770. An interface to the processor 772 may interface the operating system and the processor 710.

Firmware 790 may be provided to implement functions such as the boot sequence. An update module to enable the firmware to be updated from outside the platform 702 may be provided. For example the update module may include code to determine whether the attempt to update is authentic and to identify the latest update of the firmware 790 to facilitate the determination of when updates are needed.

In some embodiments, the platform 702 may be powered by an external power supply. In some cases, the platform 702 may also include an internal battery 780 which acts as a power source in embodiments that do not adapt to external power supply or in embodiments that allow either battery sourced power or external sourced power.

The sequences shown in FIGS. 3 and 4 may be implemented in software and firmware embodiments by incorporating them within the storage 714 or within memory within the processor 710 or the graphics subsystem 715 to mention a few examples. The graphics subsystem 715 may include the graphics processing unit and the processor 710 may be a central processing unit in one embodiment.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

As described above, system 700 may be embodied in varying physical styles or form factors. FIG. 5 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

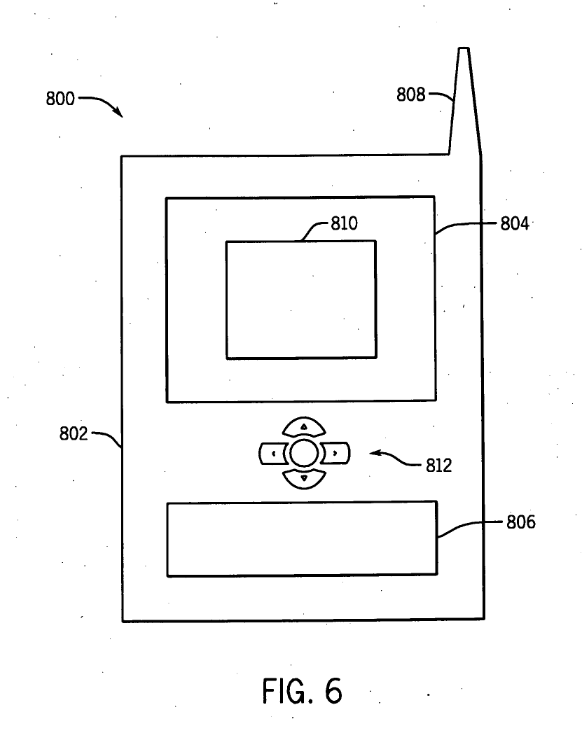

As shown in FIG. 6, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

The following clauses and/or examples pertain to further embodiments:
1. A method comprising:
   prior to tessellation, generating and storing possible stitching combinations.
2. The method of clause 1 including generating a number of stitching combinations in one processor and performing the tessellation in another processor.
3. The method of clause 2 including generating the number of stitching combinations in a central processing unit.
4. The method of clause 3 including performing the tessellation in a graphics processing unit.
5. The method of clause 4 including using only 65 external vertices and 63 interval vertices for a triangle to be tessellated.
6. The method of clause 5 including limiting the number of combinations to 4095 stitching combinations.
7. A method comprising:
   obtaining pre-computed stitching combinations in a bit mask;
   determining whether to proceed to the next vertex via an internal edge of a triangle or an external edge based on the bit mask; and
   tessellating the triangle using the stitching combinations.
8. The method of clause 7 including proceeding through internal and external edges until a center of the triangle to be tessellated is obtained and then handling the center based on whether the center is one of a quad in the form of two triangles, an inwardly facing triangle, an outwardly facing triangle, or a null center.
9. The method of clause 7 including accessing a bidirectional array providing all possible stitching combinations.
10. At least one machine readable medium comprising a plurality of instructions and, in response to being executed on a computing device, causing the computing device to carry out a method according to any one of clauses 1-9.
11. An apparatus comprising:
   a processor to process graphics by generating and storing possible stitching combinations prior to tessellation; and
   a memory coupled to said processor.
12. The apparatus of clause 11 wherein said processor is a central processing unit.
13. The apparatus of clause 11 wherein said processor is a graphics processing unit.
14. The apparatus of clause 11 including at least two processors, one processor to generate the number of stitching combinations and the other processor to perform the tessellation.
15. The apparatus of clause 14 wherein said processor to generate the number of stitching combinations is a central processing unit.
16. The apparatus of clause 15 wherein said processor to perform the tessellation is a graphics processing unit.
17. The apparatus of clause 16 wherein said central processing unit uses only 65 external vertices and 63 internal vertices for a triangle to be tessellated.
18. The apparatus of clause 17, said central processing unit to limit the number of combinations to 4095 stitching combinations.
19. An apparatus comprising:
   a processor to obtain pre-computed stitching combinations in a bit mask, determine whether to proceed to the next vertex via an internal edge of a triangle or an external edge based on the bit mask and tessellate the triangle using stitching combinations; and
   a memory coupled to said processor.
20. The apparatus of clause 19, said processor to process internal and external edges until a center of a triangle to be tessellated is obtained and then handle the center based on whether the center is one of a quad in the form of two triangles, an inwardly facing triangle, an outwardly facing triangle, or a null center.
21. The apparatus of clause 19, said processor to access a bidirectional array providing all possible stitching combinations.
22. The apparatus of clauses 11 or 17 including an operating system.
23. The apparatus of clauses 11 or 17 including a battery.
24. The apparatus of clauses 11 or 17 including firmware and a module to update said firmware.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
prior to tessellation, generating and storing possible stitching combinations.

2. The method of claim 1 including generating a number of stitching combinations in one processor and performing the tessellation in another processor.

3. The method of claim 2 including generating the number of stitching combinations in a central processing unit.

4. The method of claim 3 including performing the tessellation in a graphics processing unit.

5. The method of claim 4 including using only 65 external vertices and 63 interval vertices for a triangle to be tessellated.

6. The method of claim 5 including limiting the number of combinations to 4095 stitching combinations.

7. A method comprising:
obtaining pre-computed stitching combinations in a bit mask;
determining whether to proceed to the next vertex via an internal edge of a triangle or an external edge based on the bit mask; and
tessellating the triangle using the stitching combinations.

8. The method of claim 7 including proceeding through internal and external edges until a center of the triangle to be tessellated is obtained and then handling the center based on whether the center is one of a quad in the form of two triangles, an inwardly facing triangle, an outwardly facing triangle, or a null center.

9. The method of claim 7 including accessing a bidirectional array providing all possible stitching combinations.

10. At least one machine readable medium comprising a plurality of instructions and, in response to being executed on a computing device, causing the computing device to carry out a method comprising:
prior to tessellation, generating and storing possible stitching combinations.

11. An apparatus comprising:
a processor to process graphics by generating and storing possible stitching combinations prior to tessellation; and
a memory coupled to said processor.

12. The apparatus of claim 11 wherein said processor is a central processing unit.

13. The apparatus of claim 11 wherein said processor is a graphics processing unit.

14. The apparatus of claim 11 including at least two processors, one processor to generate the number of stitching combinations and the other processor to perform the tessellation.

15. The apparatus of claim 14 wherein said processor to generate the number of stitching combinations is a central processing unit.

16. The apparatus of claim 15 wherein said processor to perform the tessellation is a graphics processing unit.

17. The apparatus of claim 16 wherein said central processing unit uses only 65 external vertices and 63 internal vertices for a triangle to be tessellated.

18. The apparatus of claim 17, said central processing unit to limit the number of combinations to 4095 stitching combinations.

19. An apparatus comprising:
a processor to obtain pre-computed stitching combinations in a bit mask, determine whether to proceed to the next vertex via an internal edge of a triangle or an external edge based on the bit mask and tessellate the triangle using stitching combinations; and
a memory coupled to said processor.

20. The apparatus of claim 19, said processor to process internal and external edges until a center of a triangle to be tessellated is obtained and then handle the center based on whether the center is one of a quad in the form of two triangles, an inwardly facing triangle, an outwardly facing triangle, or a null center.

21. The apparatus of claim 19, said processor to access a bidirectional array providing all possible stitching combinations.

22. The apparatus of claims 19 including an operating system.

23. The apparatus of claims 19 including a battery.

24. The apparatus of claims 19 including firmware and a module to update said firmware

25. The medium of claim 10 further storing instructions to carry out a method including generating a number of stitching combinations in one processor and performing the tessellation in another processor.

26. The medium of claim 25 further storing instructions to carry out a method including generating the number of stitching combinations in a central processing unit.

27. The medium of claim 26 further storing instructions to carry out a method including performing the tessellation in a graphics processing unit.

28. The medium of claim 27 further storing instructions to carry out a method including using only 65 external vertices and 63 interval vertices for a triangle to be tessellated.

29. The medium of claim 28 further storing instructions to carry out a method including limiting the number of combinations to 4095 stitching combinations.
